(19) United States
(12) Patent Application Publication
(10) Pub. No.: US 2007/0210749 A1
(43) Pub. Date: Sep. 13, 2007

(54) Portable charger

(76) Inventor: Jason Hsieh, Taichung (TW)

Correspondence Address: Rabin & Berdo, P.C., Suite 500, 1101 14th Street, Washington, DC, 20005, US

(21) Appl. No.: 11/373,174

(22) Filed: Mar. 13, 2006

(51) Int. Cl. H02J 7/00

(52) U.S. Cl. 320/114

(57) ABSTRACT

A portable charger has a body, a rechargeable battery and a controller. The rechargeable battery is mounted inside the body and has a power capacity. The controller is mounted inside the body, is connected electrically to the rechargeable battery and has a power input unit, a power output unit and a battery indicator. The power input unit is connected to and obtains external power from an external power source to charge the rechargeable battery. The power output unit is connected to and charges different electronic devices using power in the rechargeable battery. The battery indicator indicates the remaining power capacity of the rechargeable battery.

### BACKGROUND OF THE INVENTION

1. Field of the Invention

The present invention relates to a charger, and more particularly to a portable charger that can charge different electronic devices.

2. Description of Related Art

With advances in technology and science, more and more portable electronic devices are coming onto the market. For example, people can search for information and deal with official business at any time with notebook computers, can make obstruction-free communication with cellular phones, can receive information about their daily lives and money management with PDAs (Personal Digital Assistant) and can record motion pictures with digital cameras.

Although the electronic devices currently available tend to be very friendly, battery powered electronic devices cannot work when the battery is depleted. To use these electronic devices outside, a backup rechargeable battery is necessary to continue normal operation of the electronic devices for extended periods of time. Furthermore, the rechargeable battery must be charged with AC power or power from a car's power supply prior to use and are subject to the run-time limits.

To overcome the shortcomings, the present invention provides a portable charger to obviate or mitigate the aforementioned problems.

### SUMMARY OF THE INVENTION

The main objective of the present invention is to provide a portable charger that can use different external power sources through multiple input ports and charge different kinds of electronic devices through multiple output ports.

To accomplish the foregoing objective, the portable charger in accordance with the present invention comprises a body, a rechargeable battery and a controller.

The rechargeable battery is mounted inside the body.

The controller is mounted inside the body, is connected electrically to the rechargeable battery and has a battery indicator, a power input unit and a power output unit.

The power input unit is mounted on the body and connects to an external power source to obtain electricity and to charge the rechargeable battery.

The power output unit is mounted on the body and connects to different kinds of electronic devices to charge the electronic devices using the power of the rechargeable battery.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a portable charger in accordance with the present invention;

FIG. 2 is an operational perspective view of the portable charger in FIG. 1 connected to a cellular phone;

FIG. 3 is an operational perspective view of the portable charger in FIG. 1 with the hidden connector pivoted relative to the body;

FIG. 4 is an operational perspective view of the portable charger in FIG. 1 connected to a multimedia device; and

FIG. 5 is an operational perspective view of the portable charger in FIG. 1 with an illumination device activated.

### DETAILED DESCRIPTION OF THE PREFERRED EMBODIMENT

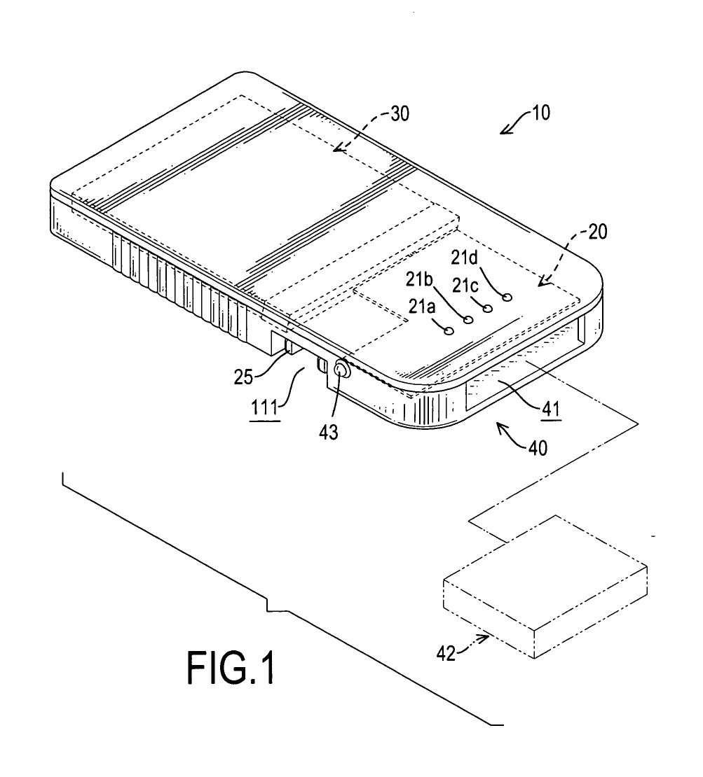

With reference to FIG. 1, a portable charger in accordance with the present invention comprises a body (10), a rechargeable battery (30), a controller (20) and an optional expansion unit (40).

The body (10) has a top, a bottom, a front, a front sidewall, a rear sidewall and an optional plug recess (111).

The plug recess (111) is formed in the front sidewall and bottom of the body (10).

The rechargeable battery (30) is mounted inside the body (10) and has a power capacity.

The controller (20) is mounted inside the body (10), is connected electrically to the rechargeable battery (30) and has a battery indicator (21), a power input unit and a power output unit.

The battery indicator (21) is mounted on the top of the body (10), is connected electrically to the rechargeable battery (30) through the controller (20) to indicate the remaining power capacity of the rechargeable battery (30) and may be implemented with multiple LEDs (21a, 21b, 21c, 21d). When the power capacity of the rechargeable battery (20) is low, only one LED (21a) lights. As the power capacity of the rechargeable battery (30) increases during charging, additional LEDs (21b, 21c) light correspondingly and accordingly. When the rechargeable battery (30) is fully charged, all LEDs (21a, 21b, 21c, 21d) light up.

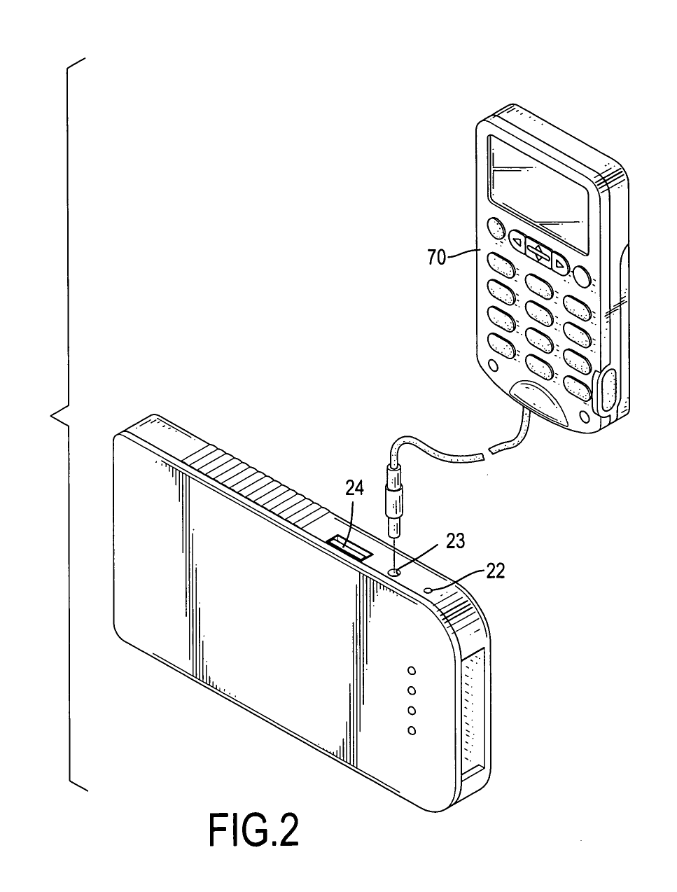

With further reference to FIG. 2, the power input unit is mounted on the body (10), connects to an external power source to obtain external electrical power to charge the rechargeable battery (30) and may be implemented with a hidden connector (25) and a power input terminal (22).

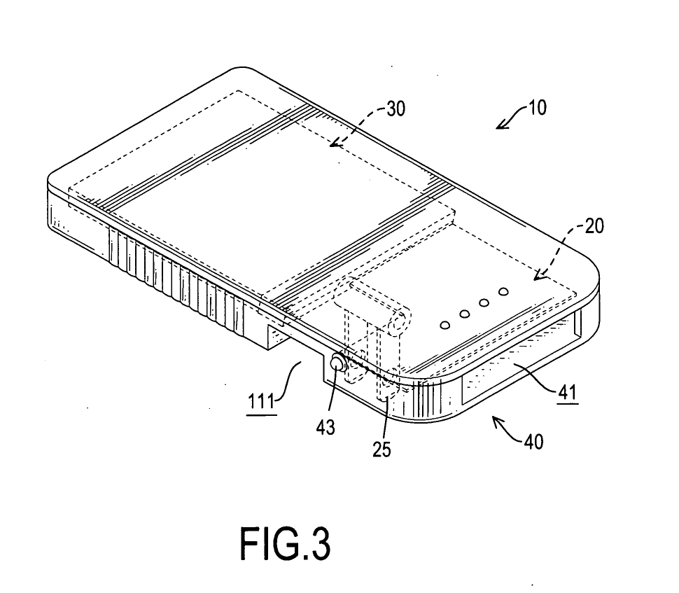

The hidden connector (25) is mounted pivotally in the plug recess (111) of the body (10), is connected to a power main with a cord to obtain electricity and to charge the rechargeable battery (30) through the controller (20) when the hidden connector (25) is pivoted perpendicular to the bottom, as shown in FIG. 3.

The power input terminal (22) is mounted in the rear sidewall of the body (10), connects to an external power source, such as an AC power source or a car power source, to charge the rechargeable battery (30) through the controller (20).

The power output unit is mounted on the body (10), connects to different electronic devices, charges the electronic devices using power from the rechargeable battery (30) and may be implemented with a cellular phone charging terminal (23) and a USB (universal series bus) interface (24).

The mobile phone charging terminal (23) is mounted in the rear sidewall of the body (10), is connected electrically to the rechargeable battery (30) through the controller (20) and charges a cellular phone (70) via a transformer.

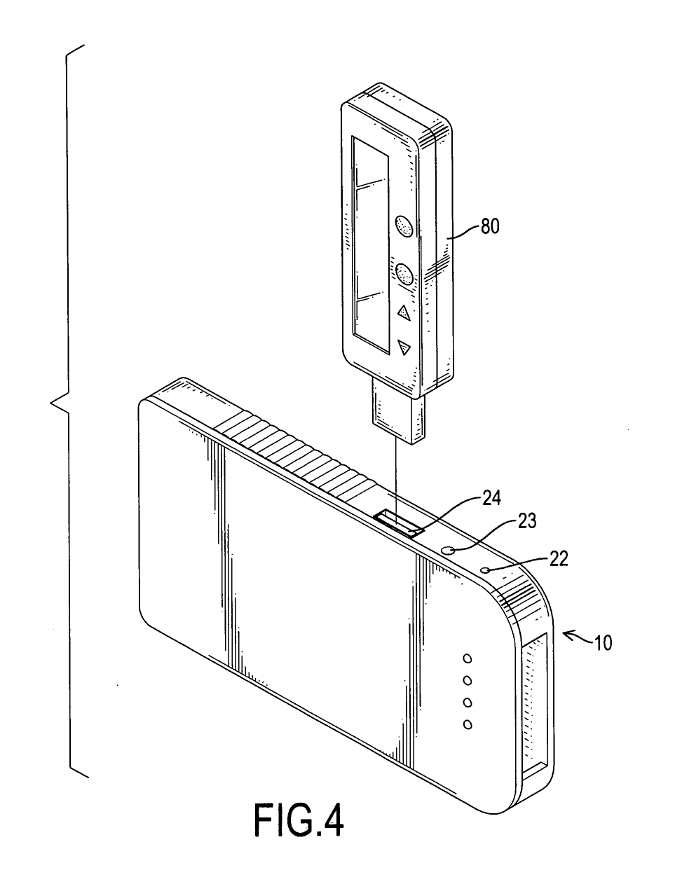

With further reference to FIG. 4, the USB interface (24) is mounted in the rear sidewall of the body (10), is connected electrically to the rechargeable battery (30) through the controller (20) and charges a multimedia device (80), such as a MP3 (MPEG Layer 3) player or a MP4 player.

The expansion unit (40) is mounted on the front of the body (10), is connected electrically to the controller (20) to provide additional function and has an expansion recess (41), an optional external expansion device (42) and a switch (43).

The expansion recess (41) is formed in the front of the body (10) and is connected electrically to the controller (20).

The external expansion device (42) is installed in the expansion recess (41) and may be implemented with an illumination device or a razor, accordingly, the portable charger can provide addition functions and is versatile in use.

The switch (43) is mounted on the front sidewall of the body (10) and is connected electrically between the rechargeable battery (30) and the expansion recess (41) to turn on and off an external expansion device installed in the expansion recess.

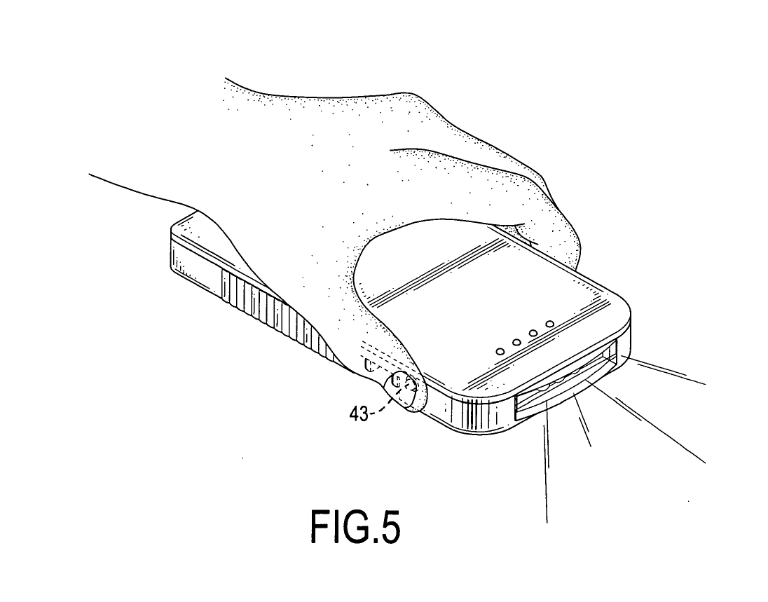

With further reference to FIG. 5, the external expansion device (42) may be an illumination device mounted in the expansion recess (41) to provide a source of light. When the switch (43) is pressed, the electrical circuit between the illumination device and the rechargeable battery (30) is complete, and the illumination device is activated and radiates light.

Based on the forgoing description, the portable charger can be recharged from different external power sources through the power input unit, can charge different external electronic devices through the power output unit and is easy and convenient to use anywhere. Moreover, the portable charger is useful in a lot of different ways when an external expansion device is mounted in the expansion unit.

Even though numerous characteristics and advantages of the present invention have been set forth in the foregoing description together with details of the structure and function of the invention, the disclosure is illustrative only. Changes may be made in detail especially in matters of shape, size, and arrangement of parts within the principles of the invention to the full extent indicated by the broad general meaning of the terms in which the appended claims are expressed.

1. A portable charger, comprising:
a body, comprising:
a top;
a bottom;
a front;
a front sidewall; and
a rear sidewall;
a rechargeable battery mounted completely inside the body and being unexposed;
a controller mounted inside the body, connected electrically to the rechargeable battery and having
a battery indicator composed of a plurality of light emitting diodes and mounted on the top of the body to indicate remaining power capacity of the rechargeable battery;
a power input unit mounted on the body to obtain an external electrical power to charge the rechargeable battery; and
a power output unit mounted on the body for charging electronic devices using power from the rechargeable battery;
an expansion unit mounted on the front of the body, connected electrically to the controller to install an external expansion device and having an expansion recess formed in the front of the body and connected electrically to the controller;
an external expansion device installed in the expansion recess; and
a switch mounted on the front sidewall of the body and connected electrically between the rechargeable battery and the expansion recess to turn on and off the external expansion device installed in the expansion recess,
wherein the external expansion device comprises an illumination device, and
wherein the power input comprises a power input terminal mounted in the rear sidewall of the body and a hidden connector mounted pivotally in the body.

2-5. (canceled)

6. The portable charger as claimed in claim 1, wherein the power input unit comprises a power input terminal mounted in the rear sidewall of the body.

7. (canceled)

8. The portable charger as claimed in claim 6, wherein the body further comprises
a plug recess formed in the right sidewall and bottom of the body; and the hidden connector is mounted pivotally in the plug recess in the body.

9. The portable charger as claimed in claim 8, wherein the power output unit comprises a cellular phone charging terminal mounted in the rear sidewall of the body.

10. The portable charger as claimed in claim 9, wherein the power output unit comprises a USB interface mounted in the rear sidewall of the body.

11-12. (canceled)

13. A portable charger, comprising:
a body comprising a top, a bottom, a front, a front sidewall, and a rear sidewall;
a rechargeable battery mounted completely inside the body and being unexposed;
a controller mounted inside the body, connected electrically to the rechargeable battery and having a battery indicator composed of a plurality of light emitting diodes and mounted on the top of the body to indicate a remaining power capacity of the rechargeable battery, a power input unit mounted on the body to obtain an external electrical power to charge the rechargeable battery and having a power input terminal mounted in the rear sidewall of the body, and a power output unit mounted on the body for charging an electronic devices using power from the rechargeable battery, wherein the power output unit has a cellular phone charging terminal mounted in the rear sidewall of the body;
an expansion unit mounted on the front of the body, connected electrically to the controller to install an external expansion device and having an expansion recess formed in the front of the body and connected electrically to the controller;
an external expansion device installed in the expansion recess; and
a switch mounted on the front sidewall of the body and connected electrically between the rechargeable battery and the expansion recess to turn on and off the external expansion device installed in the expansion recess,
wherein the external expansion device comprises an illumination device, and
wherein the power input unit comprises a power input terminal mounted in the rear sidewall of the body and a hidden connector mounted pivotally in the body, a plug recess being formed in the right sidewall and bottom of the body and the hidden connector being mounted pivotally in the plug recess in the body.
